(19) United States
(12) Patent Application Publication
(10) Pub. No.: US 2016/0180700 A1
(43) Pub. Date: Jun. 23, 2016

(54) Audible/Visible Evacuation Notification Device

(71) Applicant: Honeywell International Inc., Morristown, NJ (US)

(72) Inventor: Fred M. Butalla, III, Joliet, IL (US)

(21) Appl. No.: 14/577,536

(22) Filed: Dec. 19, 2014

(51) Int. Cl. G08B 29/12

(52) U.S. Cl. CPC G08B 29/12

(57) ABSTRACT

An output device emits alarm indicating light and sound at predetermined levels when activated. The device enters a test mode in response to received test mode indicating control signals. When the device is in the test mode, and a local test initiating control signal is received, audio and/or visual outputs are emitted at a level reduced from the alarm indicating output levels to test those outputs.

### FIELD

The application pertains to audible and/or visible alarm indicating output devices. More particularly, the application pertains to such devices which provide for un-intrusive testing of the audible and visual alarm indicating outputs.

### BACKGROUND

Regular testing of a fire system is required as per NFPA72. As a part of testing a fire system, it is important to validate that the audible/visible notification appliances on the Notification Appliance Circuit (NAC) are functioning properly. However, unlike the testing of the sensors, the testing of the NAC circuit can present some unique challenges. The sensors can be tested with little disturbance to the building occupants.

Devices on a NAC circuit on the other hand are designed to alert individuals to a fire, and therefore are meant to cause a disturbance. Depending on the building and its occupants, this can create challenges for both the occupants as well as those doing the testing. Sometimes testing needs to be done late at night when the building is unoccupied. Often times, those doing the testing will activate the NAC circuit and literally run through the building to validate that all units are operating. This can also be challenging to ensure that each device is sounding since the overall noise is quite loud.

There are other times where a building is always occupied, such as a factory where three shifts results in the building being occupied for 24 hours per day. In that situation, employees may have to step outside while the testing is conducted. This results in lost production for the company. Even greater challenges arise with buildings that are always occupied such as a hospital. In this case, patients cannot be easily moved outside. They either have to put up with the noise, or more likely, the testing is simply not done.

One system for driving and controlling such devices is disclosed in U.S. Pat. No. 5,598,139 entitled “Fire Detecting System With Synchronized Strobe Lights” which issued Jan. 28, 1997. The '139 patent is assigned to the Assignee hereof and incorporated herein by reference.

### BRIEF DESCRIPTION OF THE DRAWINGS

FIG. 1 illustrates a block diagram of a notification device in accordance herewith;

FIG. 2 is a flow diagram of a method in accordance herewith; and

FIG. 3 illustrates a timing diagram in accordance herewith.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

Embodiments hereof provide a method of testing individual devices on the NAC circuit instead of activating all the devices at the same time. The NAC circuit itself would be placed into a test state by sending specific pulses on the power lines.

While the units would have power, they would not be active since they recognize the test status indicating pulses on the line. The person conducting the test would go to each device independently and hold a magnet up to the device in order to enable that particular device to flash and/or sound. When the magnet was removed, the device would return to a standby state.

The device could be programmed such that when the magnet is sensed, the emitted intensity of the light and/or sound would be at a reduced level since the person conducting the test is directly in front of the device. This would further help to reduce the disturbance to others within the building while the test is being conducted.

Conversely, the device could instead be designed such that the intensity of the light and/or sound was not reduced. Alternately, it could even be designed that the light and/or sound level was reduced and if the magnet was still sensed after the first several seconds, then the device would revert to its full intensity until the magnet was removed.

This method of individual device testing would enable all devices within the system to be tested without creating a major disturbance to the occupants of the building, unlike traditional testing. In accordance herewith, only one unit needs to be active at a time. Multiple persons could be conducting tests at the same time at different parts of the building to decrease test time while still not disturbing everyone else on the premises.

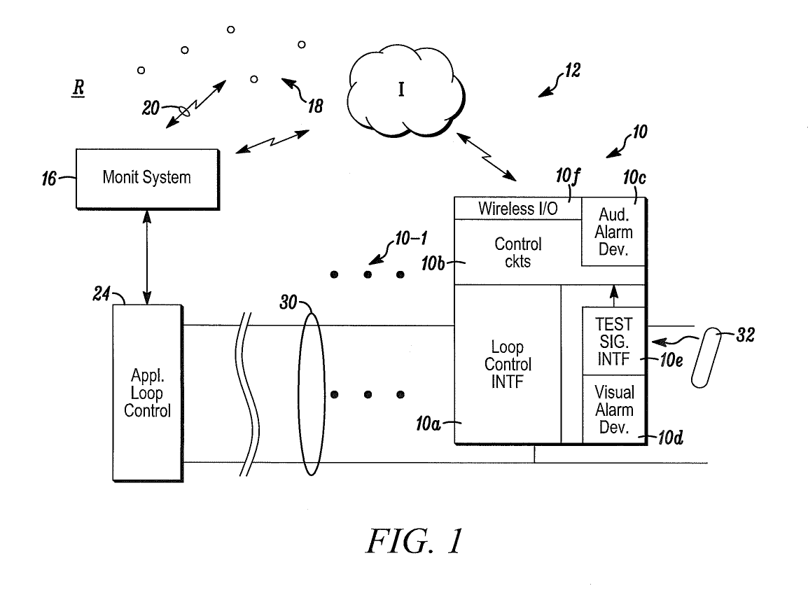

FIG. 1 illustrates a notification device 10 in accordance herewith. Device 10 is illustrated as part of a larger alarm system 12. System 12 includes a regional monitoring system 16 which communicates with a plurality of ambient condition detectors 18. The detectors 18 monitor conditions in a region R and communicate via a wired or wireless medium 20 with the monitoring system 16.

The system 16 is coupled to and in communication with an appliance loop control unit 24. As those of skill will understand, loop control circuits 24, via a wired medium 30, can provide electrical energy and control signals to a plurality of notification appliances 10-1. Appliance 10 is representative of other members of the plurality 10-1 and a discussion of appliance 10 will also apply to other members of the plurality 10-1.

Appliance 10 includes a loop control interface 10a which is coupled to the loop 30 and to control circuits 10b. The control circuits 10b are in turn coupled to an audible alarm indicating output device 10c, a visual alarm indicating output device 10d, and, a local test signal receiving interface 10e. The appliance 10 can be internet enabled and include a wireless I/O interface 10f.

Fire panels, such as system 16, and power supplies, such as 24, can provide synchronization signals by dropping the power supply to the NAC, medium 30 and plurality 10-1, to zero volts for a known amount of time.

Within the notification appliance, there is circuitry 10a to sense this dropout and measure its duration. If the pulse is too short or too long, it is ignored. Since this circuitry is available, a test mode control signal can be implemented as a dropout pulse of a unique duration on the medium 30. This pulse can be sent at a specified period so that if the pulse is no longer sensed, the device 10 will revert back to a normal operation mode. This is a fail safe solution so that the device is not be inoperable during an actual emergency.

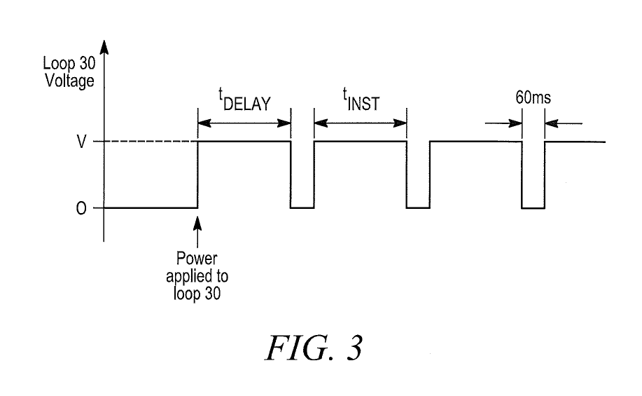

On the device 10 and other members of the plurality 10-1, the same circuitry, such as 10a, that monitors the synchronization pulses on the medium 30, can be used to detect the test mode pulses. The circuitry measures the voltage level on the NAC lines 30 and looks for it to drop below a defined threshold, best illustrated in FIG. 3. Once it reaches that threshold, it also measures the duration.

If both voltage and duration are valid, the device 10 enters a standby mode where it awaits the presence of a local test initiating signal, initiated by the device 32. The device 32 can include a magnet. The magnet can be sensed with either a reed switch or a hall effect switch in the test signal interface 10e. A magnet is not necessary. A push button or other type of switch could also be used, but a magnetic switch is cost effective and will not impact the aesthetics of the device.

Alternately, device 32 can generate a test initiating command via an emitted light beam, an acoustic output or RF-type signals directed at and received by the interface 10e. In summary, in the presence of a test mode initiated by a signal on medium 30 and a locally generated test initiating signal, from unit 32 the appliance 10 will emit one or both of a test indicating audible output and/or optical, visible light, output.

The emitted test indicating audible and visual outputs, from units 10c and 10d, exhibit a level or intensity less than a corresponding alarm indicating output.

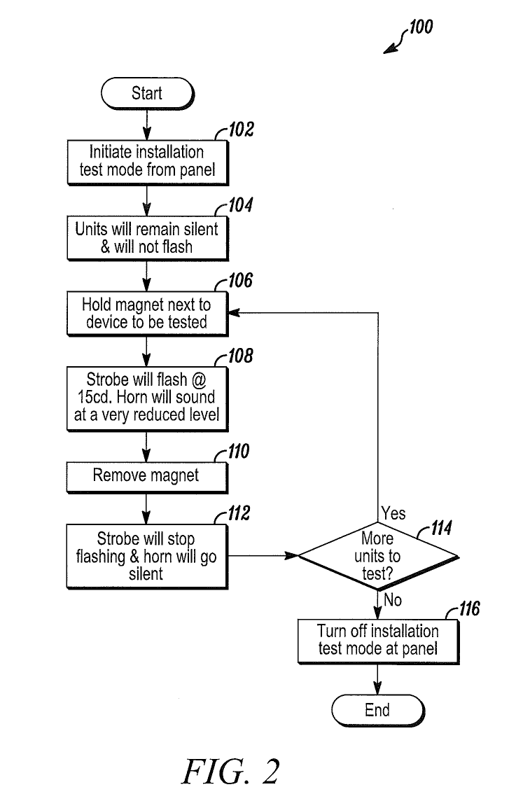

FIG. 2 illustrates as an embodiment hereof, a process 100. An installation Test Mode can be initiated at the monitoring system panel 16 which can energize the loop control 24 to emit a test mode command signal as in FIG. 3. Members of the plurality 10-1 react to the test mode control pulses by remaining silent, without audible or visual output, as at 104. As discussed above, a local test initiating control signal, from element 32 causes the members of the plurality 10-1 to emit one or both of a test indicating audible output, output device 10c, and/or a test indicating optical output, output device 10d, as at 108.

Subsequently, the local control signal is removed as at 110. In response thereto the audible output device 10c and the visual output device 10d will stop emitting respective outputs at as 112.

If there are more units to test as at 114, the above process is repeated. If not, the installation test mode is turned off at the panel 16, and loop control circuits 23, as at 116.

FIG. 3 illustrates a representative timing diagram of pulses from loop control circuitry 24 received by the members of the plurality 10-1 which place those units into an installation test mode as at 102.

Those of skill will understand that additional variations come within the scope and spirit hereof. For example, the installation test mode command signals, discussed above in connection with loop 30 can be transmitted via a computer network I, such as the internet, to the members of the plurality 10-1. Where the local signal source 32 is cause to generate the local test initiation signal for an extended period of time, the audible alarm device and visual alarm device can emit at predetermined alarm indicating levels instead of reduced test indicating levels.

From the foregoing, it will be observed that numerous variations and modifications may be effected without departing from the spirit and scope hereof. It is to be understood that no limitation with respect to the specific apparatus illustrated herein is intended or should be inferred. It is, of course, intended to cover by the appended claims all such modifications as fall within the scope of the claims. Further, logic flows depicted in the figures do not require the particular order shown, or sequential order, to achieve desirable results. Other steps may be provided, or steps may be eliminated, from the described flows, and other components may be add to, or removed from the described embodiments.

1. A test method comprising:
initiating a test mode at an alarm indicating output device; remaining silent at the device to be tested in response to the test mode;
providing a local test activating input to the device; and
responding to both the test mode and the local input by outputting at least one local test indicating indicium.

2. A method as in claim 1 where the outputting includes one of generating an audio test output, or generating a visual test output.

3. A method as in claim 1 which includes establishing at least one of an alarm indicting audio output or an alarm indicating visual output and outputting includes one of generating an audio test output, or generating a visual test output.

4. A method as in claim 3 wherein responding to the local input includes outputting the test indicium as an audio output at a lower audio level than an audible alarm is generated.

5. A method as in claim 3 wherein responding to the local input includes outputting the test indicium as a visual output at a lower candela level than a visual alarm indicating indicium is generated.

6. A method as in claim 3 where providing the local input comprises providing at least one of an optical, magnetic, acoustic or RF-type test activating input.

7. A method as in claim 6 which includes providing a portable device, and communicating the test activating input from the device to the unit being tested.

8. A method as in claim 7 where communicating includes at least one of providing a magnet and a magnetic field adjacent to the unit being tested, transmitting a visual, audible or RF-type signal from a communications device to the unit being tested.

9. A method as in claim 1 which includes selecting a unit to be tested.

10. A method as in claim 1 which includes providing a plurality of units to be tested.

11. A method as in claim 9 where communicating includes at least one of providing a magnet and a magnetic field adjacent to the unit being tested, transmitting a visual, audible or RF-type signal from a communications device to the unit being tested.

12. A method as in claim 5 which includes selecting a unit to be tested and wherein the lower audio level indicates proper operation of the unit's alarm indicating audio output element and the lower candela output of the unit's visual alarm indicating output indicates proper operation of the unit's visual alarm indicating output element.

13. A testable output device comprising:
a housing;
an audio output device carried by the housing; and
control circuits coupled to the audio output device and carried by the housing wherein the circuits respond to a selected test mode indicting signal without activating the output device and test circuits coupled to the control circuits to respond to a local test initiator and responsive thereto the control circuits activate the audio output device to output an audio test indicium.

14. An output device as in claim 13 which includes a test and alarm indicating optical output device carried by the housing which emits a visual test indicator.

15. An output device as in claim 14 wherein the test circuits respond to at least one of a manual input, magnetic input, RF-type input, optical input or acoustic input.

16. An output device as in claim 13 where the control circuits respond to a pulse of a selected duration to establish the test mode.

17. An output device as in claim 16 where the control circuits remain in the test mode substantially constantly in the presence of a train of pulses, each having the selected duration.

18. An output device as in claim 13 where the control circuits respond to duration and amplitude of the test mode indicting signal and enter a standby mode wherein if the test circuits receive the local test initiator, the control circuits activate the audio output device to output the audio test indicium.

19. An output device as in claim 18 wherein the test circuits respond to at least one of a manual input, magnetic input, RF-type input, optical input or acoustic input.

20. An output device comprising a light source and an audible source wherein alarm indicating light and audio are emitted from respective sources at predetermined, alarm indicating, levels when activated; wherein the device enters a test mode in response to received test mode indicating control signals, and, when the device is in the test mode, and a local test initiating signal is received, at least one of light and/or audio outputs are emitted at a level reduced from the alarm indicating output levels to test those outputs.
